(19) United States
(12) Patent Application Publication
(10) Pub. No.: US 2011/0172342 A1
(43) Pub. Date: Jul. 14, 2011

(54) INK COMPOSITION

(75) Inventors: Kazuaki TSUKIANA, Noamme-ken (JP); Takashi Oyanagi, Matsumoto-shi (JP)

(73) Assignee: SEIKO EPSON CORPORATION

(21) Appl. No.: 13/006,061

(22) Filed: Jan. 13, 2011

(30) Foreign Application Priority Data
Jan. 14, 2010 (JP) 2010-006206

(51) Int. Cl. C08L 33/06; C08L 33/00; C08K 3/10

(52) U.S. Cl. 524/441; 524/560; 524/523

(57) ABSTRACT

Provided is an ink composition including a metallic pigment, a metallic-pigment-fixing resin component containing poly(methyl methacrylate), and an organic solvent, but not including poly(isobutyl methacrylate).

### BACKGROUND

1. Technical Field

The present invention relates to an ink composition.

2. Related Art

Recently, ink jet technology has been broadly applied to printing, and metallic printing is one of the applications. In order to realize high quality metallic printing, it is important to use an ink composition excellent in metallic gloss.

For example, the inventors have proposed an ink composition containing a cellulose resin, and the ink composition provides relatively satisfactory metallic gloss (JP-A-2008-174712).

However, practically, the ink composition described in JP-A-2008-174712 needs to be further improved in order to enhance metallic gloss.

In addition, the viscosity of an ink composition has to be at least equivalent to those of existing ink compositions in order to avoid bleeding of ink on a recording medium and in order to stabilize discharge of ink. However, in the ink composition disclosed in JP-A-2008-174712, an increase in the amount of the cellulose resin added for enhancing metallic gloss causes a significant increase in the viscosity. Therefore, a further improvement in the ink composition is required from the viewpoint of ink-discharging stability.

### SUMMARY

An advantage of the invention is to provide an ink composition that is more excellent in metallic gloss and discharge stability, compared with known ink compositions, while maintaining the viscosity to a level equivalent to those of existing ink compositions.

The inventors investigated metallic gloss of existing ink compositions and, as a result, have found that in an ink composition containing a metallic pigment and an organic solvent, a resin for fixing the pigment to a surface of a recording medium (hereinafter, also referred to as “fixing resin component”) affects metallic gloss. That is, it has been found that in printing on a recording medium using an existing ink composition containing a cellulose resin as the fixing resin component, the pigment is fixed on the surface of the recording medium along with drying (volatilization of organic solvent) by means of the fixing resin component; in doing so, at least one of the pigment and the fixing resin component renders the surface of the image uneven, which is a factor of decreasing metallic glossiness. Furthermore, it has been found that an ink composition containing a metallic pigment and an organic solvent can maintain the viscosity thereof to a level equivalent to those of the existing ink compositions, even if the ink composition contains a fixing resin component. Accordingly, the inventors have expected that the metallic gloss and also the discharge stability of an ink composition can be improved, while maintaining the viscosity to a level equivalent to those of existing ink compositions, provided that the fixing resin component can render the surface of an image even, not uneven, and the inventors have conducted intensive studies. Thus, the invention has been accomplished.

That is, aspects of the invention are as follows:

(1) An ink composition including a metallic pigment, a metallic-pigment-fixing resin component containing poly(methyl methacrylate), and an organic solvent, but not including poly(isobutyl methacrylate);

(2) The ink composition according to aspect (1), wherein the fixing resin component further contains poly(butyl methacrylate);

(3) The ink composition according to aspect (1) or (2), wherein the fixing resin component further contains an acrylic resin;

(4) The ink composition according to any one of aspects (1) to (3), wherein the content of the fixing resin component is 0.1 to 2% by mass based on the total amount of the ink composition;

(5) The ink composition according to any one of aspects (1) to (4), wherein the fixing resin component has a glass transition temperature of 60° C. or higher;

(6) The ink composition according to any one of aspects (1) to (5), wherein the metallic pigment has a maximum particle diameter of 12 μm or less;

(7) The ink composition according to any one of aspects (1) to (6), wherein the metallic pigment is aluminum or an aluminum alloy; and

(8) The ink composition according to any one of aspects (1) to (7), wherein the ink composition has a viscosity of 8 mPa·s or less at 20° C.

### DESCRIPTION OF EXEMPLARY EMBODIMENTS

Embodiments for practicing the invention will be described in detail below. Note that the invention is not limited to the following embodiments and that various modifications can be made within the scope of the invention.

### Ink Composition

An embodiment of the invention relates to an ink composition. The ink composition includes a metallic pigment, a metallic-pigment-fixing resin component containing poly(methyl methacrylate), and an organic solvent. However, the ink composition does not include poly(isobutyl methacrylate) (hereinafter also referred to as “PiBMA”). In the ink composition not containing PiBMA, a reduction in glossiness of the ink composition can be effectively prevented.

The ink composition can be suitably applied to a purpose for achieving higher quality of metallic printing, which is one of the applications of ink jet technology, as described above. Accordingly, the ink composition of this embodiment can be defined as a solvent-based metallic ink composition for ink jet printing that enables printing an image having an excellent metallic glossy surface. The components contained in the ink composition will be described below.

### Metallic Pigment

The metallic pigment in this embodiment is preferably produced by pulverizing a metal-deposited film and is preferably in the form of plate-like particles. In the following description, the major axis and the minor axis of a main flat surface of the plate-like particle are denoted as “a” and “b”, respectively, and the thickness of the plate-like particle is denoted as “d”.

The term “plate-like particle” refers to a particle having an approximately flat surface (main flat surface) and an approximately uniform thickness (d). Since the plate-like particles are produced by pulverizing a metal-deposited film, metallic particles having an approximately flat surface and an approximately uniform thickness can be obtained. Therefore, the major axis and the minor axis of the main flat surface of the plate-like particle can be defined as “a” and “b”, respectively, and the thickness of the plate-like particle can be defined as “d”.

The main flat surface can be recognized as an elliptical surface defined by the major axis (a) and the minor axis (b).

The term “equivalent circle diameter” refers to the diameter of a circle that has the same projected area as that of the main flat surface of a plate-like particle when it projected in the thickness (d) direction of the metallic pigment particle. For example, when the main flat surface of a plate-like particle of the metallic pigment is polygonal, the equivalent circle diameter of the plate-like particle of the metallic pigment is the diameter of a circle that is obtained by converting the projected image in the thickness (d) direction of the polygonal surface into an approximately flat circle.

The 50% mean particle diameter R50 of equivalent circle diameters determined from the areas of the main flat surfaces of the plate-like particles is preferably 0.5 to 3 μm and more preferably 0.75 to 2 μm, from the viewpoints of metallic gloss and printing stability (discharge stability). A 50% mean particle diameter R50 smaller than 0.5 μm causes insufficient gloss. On the other hand, a 50% mean particle diameter R50 larger than 3 μm causes a reduction in printing stability.

In addition, the 50% mean particle diameter R50 of the equivalent circle diameters and the thickness d preferably satisfy a relationship: R50/d>5, from the viewpoint of ensuring satisfactory metallic gloss. A value of R50/d of not larger than 5 causes a problem of inferior metallic gloss.

Furthermore, the maximum particle diameter Rmax of the equivalent circle diameters determined from the areas of main flat surfaces of the plate-like particles is preferably 12 μm or less, more preferably 10 μm or less, from the viewpoint of preventing an ink jet recording apparatus from clogging of the ink composition. By controlling the Rmax to 12 μm or less, for example, the nozzle of an ink jet recording apparatus and the mesh filter disposed in an ink passage can be prevented from clogging. The term “maximum particle diameter” in this specification refers to the maximum particle diameter Rmax of equivalent circle diameters that are determined based on areas of main flat surfaces of the plate-like particles, measured with a laser diffraction/scattering particle size distribution analyzer, LMS-2000e, a product of Seishin Enterprise Co., Ltd.

The metallic pigment is not particularly limited as long as it has excellent metallic gloss, but is preferably aluminum or an aluminum alloy or silver or a silver alloy. From the viewpoints of cost performance and ensuring excellent metallic gloss, aluminum or an aluminum alloy is preferred. When the metallic pigment is an aluminum alloy, examples of a metallic element or a nonmetallic element that is added to aluminum is not particularly limited as long as it has excellent metallic gloss, and examples thereof include silver, gold, platinum, nickel, chromium, tin, zinc, indium, titanium, and copper. At least one selected from these elements, alloys thereof, and mixtures thereof is preferably used.

The metallic pigment is preferably produced by, for example, preparing plate-like particles by forming a structure (hereinafter referred to as “pigment base substrate”) in which a peeling resin layer and a metal layer (or an alloy layer) are sequentially laminated on a sheet-like base material, peeling the metal layer (or the alloy layer) from the sheet-like base material at the interface between the metal layer (or the alloy layer) and the peeling resin layer, and pulverizing and miroparticulating the metal layer (or the alloy layer). Subsequently, from the resulting plate-like particles, those of which 50% mean equivalent sphere diameter (D50) determined by light scattering described below is 0.8 to 1.2 μm are preferably collected. Alternatively, when the major axis and the minor axis of the main flat surface of the resulting plate-like particle are denoted as “a” and “b”, respectively, and the thickness of the plate-like particle is denoted as “d”, plate-like particles are preferably selected so that the 50% mean particle diameter R50 of the equivalent circle diameters determined from the areas of main flat surfaces of the plate-like particles is 0.5 to 3 μm and that the requirement of R50/d>5 are satisfied.

Specifically, the 50% mean equivalent sphere diameter determined by light scattering is measured and derived as follows: diffraction/scattering light generated by irradiating particles dispersed in a dispersion medium with light is measured with detectors disposed on the front, side, and back sides, and a point at which a distribution curve of accumulated percentage of the resulting average particle diameters crosses the horizontal axis of 50% accumulated percentage is the 50% mean particle diameter.

The term “mean equivalent sphere diameter” refers to the mean particle diameter determined based on measurement results by supposing the particles fundamentally having undefined shapes as spherical particles. An example of the measurement apparatus is a laser diffraction/scattering particle size distribution analyzer, LMS-2000e, a product of Seishin Enterprise Co., Ltd. When the 50% mean equivalent sphere diameter (D50) measured by light scattering is within the above-mentioned range, a coating film, namely, an image, having excellent metallic gloss can be formed on a printing medium, and the discharge stability of an ink from a nozzle is also enhanced.

The major axis a, the minor axis b, and the equivalent circle diameter of the main flat surface of the plate-like particles of the metallic pigment can be measured using a particle image analyzer. Examples of the particle image analyzer include flow particle image analyzers produced by Sysmex Corporation: FPIA-2100, FPIA-3000, and FPIA-3000S.

The particle size distribution (CV value) of the plate-like particles of the metallic pigment can be determined by the following equation (1):

[Equation 1]

CV value=(standard deviation of particle size distribution)/(average particle diameter)×100 (1).

Here, the resulting CV value is preferably 60 or less, more preferably 50 or less, and most preferably 40 or less. By selecting metallic pigment so as to have a CV value of 60 or less, excellent printing stability can be advantageously achieved.

The metal layer or the alloy layer is preferably formed by vacuum deposition, ion plating, or sputtering.

The thickness of the metal layer or the alloy layer is preferably 5 to 100 nm and more preferably 20 to 100 nm. By doing so, pigment having an average thickness of preferably 5 to 100 nm and more preferably 20 to 100 nm can be obtained. An average thickness of 5 nm or more provides excellent reflection and brilliance to increase the performance as a metallic pigment. On the other hand, an average thickness of 100 nm or less inhibits an increase in apparent specific gravity to ensure dispersion stability of the metallic pigment.

The peeling resin layer of the pigment base substrate is an under coat layer for the metal layer or the alloy layer and serves as a peelable layer for improving the peelability from the surface of the sheet-like base material. The resin used for the peeling resin layer is preferably at least one selected from the group consisting of polyvinyl alcohol, polyvinyl butyral, polyethylene glycol, polyacrylic acid, polyacrylamide, cellulose derivatives such as cellulose acetate butyrate (CAB), acrylic acid polymers, and denatured nylon resins.

The peeling resin layer can be formed by applying a solution containing at least one of the above-mentioned resins onto the sheet-like base material, followed by drying to form a layer. The application solution can contain an additive such as a viscosity modifier.

The application of the peeling resin layer can be performed by a common process such as gravure coating, roll coating, blade coating, extrusion coating, dip coating, or spin coating. After the application and drying, according need, the surface may be smoothed by calendar treatment.

The thickness of the peeling resin layer is not particularly limited, but is preferably 0.5 to 50 μm and more preferably 1 to 10 μm. A thickness smaller than 0.5 μm is an insufficient amount as a dispersion resin. A thickness larger than 50 μm tends to cause peeling at the interface with the pigment layer when rolled.

The sheet-like base material is not particularly limited, and examples thereof include polyester films such as polytetrafluoroethylene, polyethylene, polypropylene, and polyethylene terephthalate; polyamide films such as Nylon 66 and Nylon 6; and release films such as polycarbonate films, triacetate films, and polyimide films. Preferred sheet-like base materials are polyethylene terephthalate and copolymers thereof.

The thickness of the sheet-like base material is not particularly limited, but is preferably 10 to 150 μm. A thickness of 10 μm or more does not cause problems in handling during a processing step and so on, and a thickness of 150 μm or less provides high flexibility not to cause problems in rolling, peeling, and so on.

The metal layer or the alloy layer may be disposed between protection layers, as described in JP-A-2005-68250. Examples of the protection layers include silicon oxide layers and resin protection layers.

The silicon oxide layer is not particularly limited as long as the layer contains silicon oxide, but is preferably formed by a sol-gel method from an silicon alkoxide such as tetraalkoxysilane or a polymer thereof.

The silicon oxide layer is formed as a coating film by applying an alcohol solution dissolving silicon alkoxide or a polymer thereof, followed by heating and baking.

The protection resin layer is not particularly limited as long as the layer is made of a resin that is not dissolved in a dispersion medium. Examples of the resin include polyvinyl alcohol, polyethylene glycol, polyacrylic acid, polyacrylamide, and cellulose derivatives, and the layer is preferably made of polyvinyl alcohol or a cellulose derivative.

The protection resin layer is formed by applying an aqueous solution of one or more of the above-mentioned resins, followed by drying to form a layer. The application solution can contain an additive such as a viscosity modifier.

The application of the silicon oxide or the resin is performed by a method similar to the application of the peeling resin layer.

The thickness of the protection layer is not particularly limited, but is preferably in the range of 50 to 150 nm. A thickness of smaller than 50 nm causes insufficient mechanical strength, but a thickness of larger than 150 nm causes difficulties in pulverization and dispersion due to too high strength and may also cause peeling at the interface with the metal layer (or the alloy layer).

Furthermore, a color material layer may be disposed between the protection layer and the metal layer (or the alloy layer), as described in JP-A-2005-68251.

The color material layer is disposed for obtaining an appropriate colored composite pigment and is not particularly limited as long as it can contain a color material that can provide intended tone and hue, in addition to the metallic gloss and brilliance of the metallic pigment used in the embodiment. The color material used in the color material layer may be either a dye or a pigment, and known dyes and pigments can be appropriately used.

In this case, the “pigment” used in the color material layer refers to those defined in the field of general gigment chemistry, such as natural pigments, synthetic organic pigments, and synthetic inorganic pigments and differs from those processed into a laminate structure, such as pigments in this embodiment.

The color material layer may be formed by any method without particular limitation, but is preferably formed by coating.

When the color material contained in the color material layer is a pigment, it is preferable that the layer further contain a color material-dispersing resin. The color material layer containing the color material-dispersing resin is preferably formed as a thin resin film by dispersing or dissolving the pigment, the color material-dispersing resin, and, according to need, other additives in a solvent and forming a uniform liquid film of the resulting solution or dispersion by spin coating, followed by drying.

It is preferable that both the color material layer and the protection layer be formed by coating when the pigment base substrate is produced, from the standpoint of work efficiency.

The pigment base substrate can have a layer configuration having a plurality of laminate structures each composed of the peeling resin layer, the metal layer (or the alloy layer), and the protection layer sequentially laminated. In such a case, the total thickness of the laminate structures including a plurality of the metal layers (or the alloy layers), that is, the thickness of (metal layer or alloy layer/peeling resin layer/metal layer or alloy layer), or (peeling resin layer/metal layer or alloy layer), excluding the sheet-like base material and the peeling resin layer disposed directly thereon, is preferably 5000 nm or less. When the thickness is not larger than 5000 nm, cracking and peeling are hardly caused in the pigment base substrate even when it is rolled and thus provides excellent storage properties. In addition, excellent brilliance is maintained after being formed into a pigment.

Furthermore, the peeling resin layer and the metal layer (or the alloy layer) may be laminated alternately on each of both surfaces of the sheet-like base material, but the configuration is not limited to these structures.

The peeling method from the sheet-like base material is not particularly limited, but preferred are as follows: a method in which a liquid (solvent) is sprayed to the pigment base substrate, and then the metal layer (or the alloy layer) of the base substrate is scraped and collected; a method in which the pigment base substrate is immersed in a liquid; and a method in which the pigment base substrate is immersed in a liquid and is simultaneously sonicated for peeling and pulverizing the peeled pigment at the same time. According to these methods, in addition to the peeled metal layer (or alloy layer), the liquid used for the peeling treatment can be collected. Examples of the liquid (solvent) used in such peeling treatment include glycol ether solvents, lactone solvents, and mixtures thereof.

The method of pulverizing and miroparticulating the peeled metal layer (or alloy layer) is not particularly limited, and may be a known method using, for example, a ball mill, a bead mill, or a jet mill or by sonication. Thus, the metallic pigment is obtained.

In the thus obtained pigment, the peeling resin layer functions as protective colloid, and thereby a stable pigment dispersion can be obtained by merely performing dispersion treatment in a solvent. In an ink composition containing such a pigment, the resin derived from the peeling resin layer also has a function of providing adhesiveness to a recording medium.

The concentration of the metallic pigment in the ink composition according to the embodiment is preferably 0.1 to 3.0% by mass and more preferably 0.5% to 2.0% when only one ink in an ink set is the metallic ink. When the concentration of the metallic pigment in the ink composition is not less than 0.5% by mass and less than 1.7% by mass, a half-mirror-like gloss surface, that is, a gloss surface is obtained by discharging the ink in an insufficient amount for covering the printing surface. Furthermore, in such a case, it is possible to print a tone that allows seeing the background through the printing, and a metallic gloss surface excellent in gloss can be formed by discharging the ink in a sufficient amount for covering the printing surface. Accordingly, such an ink composition is suitable for, for example, forming a half-mirror image on a transparent recording medium or realizing a metallic gloss surface excellent in gloss.

When the concentration of the metallic pigment in the ink composition is 1.7% by mass or more and 2.0% by mass or less, the metallic pigment is randomly aligned on a printing surface. Therefore, satisfactory metallic gloss is not obtained, and matte metallic gloss can be formed. Accordingly, such an ink composition is suitable for forming a shielding layer on a transparent recording medium.

The ink composition according to the embodiment may contain a dispersion medium for dispersing the metallic pigment. The dispersion medium is not particularly limited, and examples thereof include glycol ethers such as diethylene glycol diethyl ether, triethylene glycol monobutyl ether, dipropylene glycol dimethyl ether, dipropylene glycol diethyl ether, and ethylene glycol monoallyl ether; ether acetates such as propylene glycol methyl ether acetate; lactones such as γ-butyrolactone; and alcohols such as isopropyl alcohol.

### Fixing Resin Component

The fixing resin component in this embodiment contains poly(methyl methacrylate) (hereinafter also referred to as “PMMA”).

As described above, the inventors have found that metallic gloss and discharge stability are affected by a fixing resin component in an ink composition containing a metallic pigment and an organic solvent. Accordingly, the inventors have further investigated the fixing resin component for its influence on metallic gloss and discharge stability in the ink composition. The investigation results will be described in detail below.

It has been revealed that when a fixing resin component is dissolved in an organic solvent and the ink is solidified by drying (volatilization of the organic solvent), the surface condition of a recording medium after the drying is smooth or rough; when the surface of the recording medium is smooth, satisfactory gloss is maintained to allow a glossy metallic surface to have a higher glossiness; and, conversely, when the surface condition of the recording medium is rough, irregular reflection occurs to make the surface appearance whitish, which causes a lower glossiness of the glossy metallic surface. Furthermore, it has been confirmed that the surface after drying becomes rough when a known cellulose resin is used as the fixing resin component. On the other hand, it has been found that when at least PMMA is contained in the fixing resin component, an image surface after drying can be maintained smooth, resulting in an improvement of the metallic gloss of the surface.

Whether the surface condition of a recording medium is smooth or rough highly affects, in particular, oriented film printing to cause a large difference in quality. That is, in oriented film printing, the degree of orientation of a metallic pigment when the surface condition of a recording medium is smooth is higher than that when the surface condition of the recording medium is rough. The higher the degree of orientation is, the higher the degree of gloss of the surface of a recording medium will become. Therefore, in the ink composition of the embodiment in which at least PMMA is contained in the fixing resin component, the glossiness of the surface of a printed material obtained by oriented film printing is further increased, compared to existing ink compositions containing cellulose resins, while the viscosity of the ink composition is maintained to a level equivalent to those of the existing ink compositions. As the results, according to the ink composition of the embodiment, the printed material can have excellent quality.

From the viewpoint similar to the above, the fixing resin component preferably further contains poly(butyl methacrylate) (hereinafter also referred to as “PBMA”), and is more preferably composed of PMMA alone or PMMA and PBMA and is more preferably composed of PMMA and PBMA.

The PBMA can control the solubility of PMMA and the hardness of an acrylic resin.

The fixing resin component may further contain a resin other than PMMA, PBMA, and PiBMA. Examples of the resin other than PMMA, PBMA, and PiBMA include acrylic resins produced from at least either acrylic ester or methacrylic ester (except PMMA, PBMA, and PiBMA), copolymers thereof with styrene (i.e., styrene-acrylic resins), modified rosin resins, terpene-based resins, modified terpene resins, polyester resins, polyamide resins, epoxy resins, vinyl chloride resins, vinyl chloride-vinyl acetate copolymers, polyvinyl butyrals, polyacrylic polyols, polyvinyl alcohols, polyurethanes, and hydrogenated petroleum resins. In particular, acrylic resins excluding PMMA, PBMA, and PiBMA are preferred.

The content of the resin other than PMMA and PBMA in the fixing resin component in the embodiment preferably 0.5 to 2.0% by mass, more preferably 1.0 to 2.0% by mass, based on the total amount of the fixing resin component.

The fixing resin component may be a non-aqueous emulsion of polymer microparticles, which is a dispersion in which microparticles of, for example, a polyurethane resin, an acrylic resin, or an acrylic polyol resin are stably dispersed in an organic solvent. Examples of the polyerethane resin include Sanprene IB-501 and Sanprene IB-F370, products of Sanyo Chemical Industries, Ltd., and examples of the acrylic polyol resin include N-2043-60MEX, a product of Harima Chemicals, Inc.

The non-aqueous emulsion of polymer particles is also referred to as non-aqueous dispersion (NAD) resin.

The upper limit of the content of the fixing resin component is preferably 5.0% by mass, more preferably 4.0% by mass, more preferably 3.0% by mass, more preferably 2.0% by mass, more preferably 1.5% by mass, and most preferably 1.0% by mass, based on the amount of the ink composition. The printing stability can be further increased by controlling the upper limit of the content within the above-mentioned range. The lower limit of the content of the fixing resin component preferably 0.05% by mass, more preferably 0.1% by mass, more preferably 0.2% by mass, more preferably 0.3% by mass, more preferably 0.4% by mass, and most preferably 0.5% by mass. The ability of fixing the pigment to a recoding medium can be further enhanced by controlling the lower limit of the content within the above-mentioned range.

The glass transition temperature (Tg) of the fixing resin component is preferably 60° C. or higher. In such temperature, the glossiness can be further increased.

### Organic Solvent

The ink composition of this embodiment includes an organic solvent. The organic solvent is not particularly limited, but is preferably a polar organic solvent. Examples of the polar organic solvent include, but are not limited to, alcohols (e.g., methyl alcohol, ethyl alcohol, propyl alcohol, butyl alcohol, isopropyl alcohol, and fluorinated alcohols), ketones (e.g., acetone, methyl ethyl ketone, and cyclohexanone), carboxylic acid esters (e.g., methyl acetate, ethyl acetate, propyl acetate, butyl acetate, methyl propionate, and ethyl propionate), and ethers (e.g., diethyl ether, dipropyl ether, tetrahydrofuran, and dioxane). These organic solvents may be used alone or in combination.

When two or more organic solvents are contained in the ink composition, the dispersion medium and/or at least one of the organic solvents preferably contains at least one dispersion solvent and/or at least one organic solvent that is uniformly miscible with water. More preferably, the dispersion medium is a dispersion medium that is uniformly miscible with water, and at least one of the organic solvents is an organic solvent that is uniformly miscible with water.

In particular, at least one of the organic solvents is preferably one or more alkylene glycol ethers that are liquids at ordinary temperature and ordinary pressure.

The alkylene glycol ethers include ethylene glycol ethers and propylene glycol ethers, based on each group of aliphatic groups (methyl, n-propyl, i-propyl, n-butyl, butyl, hexyl, and 2-ethylhexyl) and allyl and phenyl groups having double bonds. These alkylene glycol ethers are colorless and low in odor, and, since they have an ether group and a hydroxyl group in each molecule, have both characteristics from the alcohols and the ethers and are liquids at ordinary temperature. In addition, monoethers, in which only one hydroxyl group is substituted, and diethers, in which both hydroxyl groups are substituted, can be used in combination.

The organic solvent is preferably a mixture of at least two selected from the group consisting of alkylene glycol diethers, alkylene glycol monoethers, and lactones.

Examples of the alkylene glycol monoether include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, dipropylene glycol monomethyl ether, and dipropylene glycol monoethyl ether.

Examples of the alkylene glycol diether include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

In addition, their derivatives, i.e., alkylene glycol monoalkyl ether acetates, can be used. Examples of the alkylene glycol monoalkyl ether acetates include ethylene glycol monoethyl ether acetate, diethylene glycol monoethyl ether acetate, propylene glycol ether acetate, and dipropylene monoethyl ether acetate.

Examples of the lactone include γ-butyrolactone, δ-valerolactone, and ε-caprolactone.

### Other Components

The ink composition of this embodiment may contain components other than the above-described components and preferably contains at least one selected from glycerin, polyalkylene glycol, and saccharides. The total amount of the at least one selected from glycerin, polyalkylene glycol, and saccharides is preferably 0.1% by mass or more and 10% by mass or less based on the amount of the ink composition. By providing such a suitable constitution, drying of the ink can be suppressed, clogging is prevented, discharging of the ink is stabilized, and the image quality of a recorded matter is increased.

The polyalkylene glycol is a linear polymer compound having a structure in which ether bonds are repeated in its main chain and is produced by, for example, ring-opening polymerization of cyclic ethers.

Examples of the polyalkylene glycol include polymers such as polyethylene glycol and polypropylene glycol, ethylene oxide-propylene oxide copolymers, and derivatives thereof. The copolymers may be any of random copolymers, block copolymers, graft copolymers, and alternating copolymers.

Preferred examples of the polyalkylene glycol are represented by the following formula (I):

[Formula 1]

HO—(CₙH₂ₙO)ₘ—H (1)

(in the formula, n denotes an integer of 1 to 5, and m denotes an integer of 1 to 100).

In the formula, the integer, n, in (CₙH₂ₙO)ₘ may be either a single constant or a combination of two or more constants within the above-mentioned range. For example, when n is 3, the formula gives (C₃H₆O)ₘ, and when n is a combination of 1 and 4, the formula gives (CH₂O—C₄H₈O)ₘ. The integer, m, may be either a single constant or a combination of two or more constants within the above-mentioned range. For example, when m is a combination of 20 and 40 in the above example, the formula gives (CH₂O)₂₀—(C₄H₈O)₄₀, and m is a combination of 10 and 30, the formula gives (CH₂O)₁₀—(C₄H₈O)₃₀. In addition, the integers, n and m, may be any combination within the above-mentioned ranges.

Examples of the saccharide include monosaccharides such as pentose, hexose, heptose, and octose; polysaccharides such as disaccharides, trisaccharides, and tetrasaccharides; and derivatives thereof, for example, reduced derivatives such as sugar alcohols and deoxy sugars, oxidized derivatives such as aldonic acid and uronic acid, dehydrated derivatives such as glycoseen, amino sugars, and thio sugars. The term “polysaccharides” refers to sugars in a broad sense, including substances that are present widely in nature, such as alginic acid, dextrin, and cellulose.

The ink composition preferably contains at least one selected from acetylene glycol surfactants and silicone surfactants. The amount of the surfactant is preferably 0.01% by weight or more and 10% by weight or less of the content of the pigment in the ink composition.

By providing such a suitable constitution, the affinity (wettability) of the ink composition to a recording medium is improved to provide a rapidly adhering ability.

Preferred examples of the acetylene glycol surfactant include Surfynol 465 (trademark) and Surfynol 104 (trademark) (which are trade names, manufactured by Air Products and Chemicals, Inc.) and Olfine STG (trademark) and Olfine E1010 (trademark) (which are trade names, manufactured by Nissin Chemical Industry Co., Ltd.).

The silicone surfactant is preferably polyester-modified silicone or polyether-modified silicone. Examples of the silicone surfactant include BYK-347, BYK-348, BYK-UV3500, BYK-UV3570, BYK-UV3510, and BYK-UV3530 (BYK Additives & Instruments).

The ink composition can be prepared by a well-known common process. For example, first, the above-described metallic pigment, a dispersant, and a solvent are mixed; a pigment dispersion is prepared using a ball mill, a bead mill, or a jet mill or by sonication; and the resulting pigment dispersion is adjusted so as to have desired ink characteristics, followed by addition of a binder resin, the solvent, and other additives (for example, a dispersion aid and a viscosity modifier) with stirring to give a pigment ink composition.

As another example, the composite pigment base substrate is sonicated in a solvent once to form a composite pigment dispersion, and then the dispersion may be mixed with a necessary ink solvent. Alternatively, the composite pigment base substrate may be directly sonicated in an ink solvent to directly form an ink composition.

### Physical Properties of Ink Composition

In order to avoid bleeding of ink on a recording medium and in order to stabilize discharge of ink, it is necessary to maintain the viscosity of the ink composition to a level at least equivalent to those of existing ink compositions.

The viscosity at 20° C. of the ink composition of this embodiment is preferably 8 mPa·s or less, more preferably 5 mPa·s or less, and most preferably 2 to 4 mPa·s. Within the range, the uniformity of printing is further improved. In this specification, the viscosity at 20° C. is a value measured by a method conducted in “Examples” described below.

Avoidance of bleeding of ink on a recording medium and stabilization of discharge of ink can be also achieved by controlling the surface tension of the ink composition within a predetermined range. The surface tension of the ink composition in the embodiment is preferably 20 to 50 mN/m. A surface tension of 20 mN/m or more can prevent the ink composition from wetting and spreading on the surface of a printer head for ink jet recording or from bleeding. A surface tension of 50 mN/m or less can ensure discharge stability of ink droplets. In this specification, the surface tension is a value measured by a plate method.

Regarding the metallic glossiness (hereinafter simply referred to as “glossiness”) of the ink composition in the embodiment, a preferred value and its measuring process will be described below.

Thus, according to the embodiment, an ink composition that is more excellent in metallic gloss and discharge stability, compared to those of existing ink compositions, can be provided, while maintaining the viscosity to a level at least equivalent to those of existing ink compositions.

Furthermore, the inventors have confirmed that the viscosity of the ink composition of the embodiment containing at least PMMA is equivalent to that of an existing ink composition containing a cellulose resin and that the metallic gloss and the discharge stability of the ink composition of the embodiment are significantly excellent compared to those of the existing ink composition.

### Ink Jet Recording Process

In the ink jet recording process according to an embodiment of the invention, recording is performed by discharging droplets of the above-described ink composition and letting the droplets adhere to a recording medium.

When the recording medium has an ink-receiving layer, the printing is preferably performed with heating the recording medium, from the viewpoint of that satisfactory gloss can be provided by performing the drying in printing at a temperature of 35 to 45° C.

Examples of the heating process include heating by bringing a heat source into contact with a recording medium and heating, without contact with a recording medium, by irradiating the recording medium with, for example, infrared rays or microwaves (electromagnetic waves having a maximum wavelength of about 2450 MHz) or by blowing hot air to the recording medium.

The heating is preferably performed during the process of printing. The heating temperature depends on the type of a recording medium, but is preferably 30 to 50° C. and more preferably 35 to 45° C.

In the ink jet recording process of the embodiment, the above-described ink composition is used. Therefore, the ink composition can inhibit undesired chemical reactions described above and also can inhibit a decrease in gloss and generation of gas even under a high-temperature environment.

### EXAMPLES

Embodiments of the invention will be further specifically described by examples below, but are not limited to these examples.

### Example 1

### 1. Preparation of Metallic Pigment Dispersion

A resin layer coating solution containing 3% by mass of cellulose acetate butyrate (butylation rate: 35 to 39%, manufactured by Kanto Chemical Co., Inc.) and 97% by mass of diethylene glycol diethyl ether (manufactured by Nippon Nyukazai Co., Ltd.) was uniformly applied onto a PET film having a thickness of 100 μm by bar coating, followed by drying at 60° C. for ten minutes to form a resin-layer thin film on the PET film.

Subsequently, an aluminum deposited layer having an average thickness of 20 nm was formed on the resin layer using a vacuum evaporator, VE-1010 vacuum evaporator, (a product of Vacuum Device Inc.).

Then, the laminate thus-formed was peeled, pulverized, and dispersed in diethylene glycol diethyl ether at the same time using VS-150 ultrasonic disperser (a product of AS ONE Corporation) to yield a metallic pigment dispersion, where the total ultrasonic dispersion time was 12 hours.

The resulting metallic pigment dispersion was filtered through a SUS mesh filter having a pore size of 5 μm to remove coarse particles. The filtrate was then put into a round-bottomed flask, and diethylene glycol diethyl ether was distilled off using a rotary evaporator. As a result, the metallic pigment dispersion was concentrated. Subsequently, the concentration of the metallic pigment in the dispersion was adjusted to 5% by mass.

The 50% mean equivalent sphere diameter (D50) of the metallic pigments measured by light scattering using a laser diffraction/scattering particle size distribution analyzer, LMS-2000e (a product of Seishin Enterprise Co., Ltd.) was 1.0011 μm. The maximum particle diameter was 5.01 μm.

Furthermore, the moisture content in the metallic pigment dispersion measured using a micro-moisture meter, FM-300A (a product of Kett Electric Laboratory) was 0.58% by mass. The moisture content in diethylene glycol diethyl ether (manufactured by Nippon Nyukazai Co., Ltd.) was 0.38% by mass.

### 2. Preparation of Metallic Pigment Ink Composition

A metallic pigment ink composition having the composition shown in Table 1 was prepared using the metallic pigment dispersion prepared by the above-described process: additives and solvents were mixed and dissolved to obtain an ink solvent, and then the metallic pigment dispersion was added to the ink solvent, followed by mixing/stirring with a magnetic stirrer for 30 minutes at ordinary temperature and ordinary pressure to obtain the metallic pigment ink composition.

As the resin, poly(methyl methacrylate) (PMMA) (PARALOID (trademark) B-44 100%, a product of Rohm and Haas Company) was used. As the organic solvents, diethylene glycol diethyl ether (DEGdEE), tetraethylene glycol dimethyl ether (TEGdME), and tetraethylene glycol monobutyl ether (TEGmBE) (these are products manufactured by Nippon Nyukazai Co., Ltd.), and γ-butyrolactone (γ-BL) (manufactured by Kanto Chemical Co., Inc.) were used. The unit is % by mass.

### Example 2

A metallic pigment ink composition was prepared as in Example 1 except that PMMA/PBMA (PARALOID (trademark) B-64, a product of Rohm and Haas Company) was used instead of the resin used in “2. Preparation of metallic pigment ink composition”.

The “PPMA/PBMA” means a copolymer of methyl methacrylate (MMA) and butyl methacrylate (BMA).

### Comparative Example 1

A metallic pigment ink composition was prepared as in Example 1 except that poly(isobutyl methacrylate) (PiBMA) (PARALOID (trademark) B-67 100%, a product of Rohm and Haas Company) was used instead of the resin used in “2. Preparation of metallic pigment ink composition”.

### Comparative Example 2

A metallic pigment ink composition was prepared as in Example 1 except that cellulose acetate butyrate (CAB) (manufactured by Kanto Chemical Co., Inc., butylation rate: 35 to 39%) was used instead of the resin used in “2. Preparation of metallic pigment ink composition”.

TABLE 1

| | | | Comparative | Comparative |
|---|---|---|---|---|
| | Example 1 | Example 2 | Example 1 | Example 2 |
| Al content | 24 | 24 | 24 | 24 |
| (solid content | | | | |
| in metallic pigment | | | | |
| dispersion) | | | | |
| PMMA | 1.5 | — | — | — |
| PMMA/PBMA | — | 1.0 | — | — |
| PiBMA | — | — | 2.5 | — |
| CAB | — | — | — | 8 |
| DEGdEE | 46.5 | 47 | 45.5 | 39.8 |
| γ-BL | 10 | 10 | 10 | 10 |
| TEGdME | 15 | 15 | 15 | 15 |
| TEGmBE | 3 | 3 | 3 | 3 |

### Example 3

Metallic pigment ink compositions were prepared as in Example 1 except that the contents of PMMA were changed to 0.2% by mass, 0.5% by mass, 1.0% by mass, 1.5% by mass, 2.0% by mass, and 5.0% by mass and that the content of DEGdEE was changed so as to compensate the change in content of PMMA.

### Example 4

Metallic pigment ink compositions were prepared as in Example 2 except that the contents of PMMA/PBMA were changed to 0.2% by mass, 0.5% by mass, 1.0% by mass, 1.5% by mass, 2.0% by mass, and 5.0% by mass and that the content of DEGdEE was changed so as to compensate the change in content of PMMA/PBMA.

### Comparative Example 3

Metallic pigment ink compositions were prepared as in Comparative Example 2 except that the contents of CAB were changed to 0.2% by mass, 0.5% by mass, and 1.0% by mass and that the content of DEGdEE was changed so as to compensate the change in content of CAB.

### 3. Evaluation Test

### (1) Glossiness Test

Each ink composition of Examples and Comparative Examples was mounted on the cyan column of an ink jet printer, SP-300V (a product of Roland DG Corporation). Solid printing was performed on a medium (Product No.: SV-G610G, a product of Roland DG Corporation) processed to an A4 size at a very fine mode under an ordinary temperature environment. Glossiness was measured with a glossmeter, Multigloss 268 (a product of Konica Minolta Holdings, Inc.). The resulting image (printing) of 16 cm×16 cm was dried, and the 20-degree glossiness in the direction perpendicular to the main scanning direction was measured at ten points, and the average of the values at the ten points was evaluated.

Table 2 shows the results in Examples 1 and 2 and Comparative Examples 1 and 2. The results of Examples 3 and 4 and Comparative Example 3 were evaluated according to the following criteria:

AA: glossiness was 300 or more,

A: glossiness was 250 or more and less than 300,

B: glossiness was 200 or more and less than 250, and

C: glossiness was less tan 200.

The results are shown in Table 3.

### (2) Viscosity Test

The viscosities at 20° C. of the ink compositions of Examples 1 and 2 and Comparative Examples 1 and 2 were measured with a rheometer (MCR300, Paar Physca). The results are shown in Table 2.

### (3) Discharge Evaluation Test

Each ink composition of Examples 3 and 4 and Comparative Example 3 was mounted on the cyan column of an ink jet printer, SP-300V (a product of Roland DG Corporation). Solid printing (an image of a size of 50 mm×200 mm) was performed on a medium (Product No.: SV-G610G, a product of Roland DG Corporation) at a very fine mode under an ordinary temperature environment.

The discharge stability (discharge performance) was evaluated according to the following criteria:

A: no ink scattering occurred in 50 mm×200 mm printing,

B: ink scattering occurred partially in 50 mm×200 mm printing,

C: ink scattering occurred entirely in 50 mm×200 mm printing, and

D: discharge was impossible.

The results are shown in Table 3.

TABLE 2

| | | | Comparative | Comparative |
|---|---|---|---|---|
| | Example 1 | Example 2 | Example 1 | Example 2 |
| Tg (° C.) | 60 | 60 | 50 | — |
| Glossiness | 276 | 304 | 30 | 220 |
| Viscosity (mPa · s) | 3.34 | 2.97 | 3.28 | 3.03 |

TABLE 3

| Test division\Content (mass %) | | 0.2 | 0.5 | 1.0 | 1.5 | 2.0 | 5.0 |
|---|---|---|---|---|---|---|---|
| Example 3 | Glossiness | AA | AA | AA | A | B | C |
| (PMMA) | Discharge | A | A | A | A | B | C |
| | performance | | | | | | |
| Example 4 | Glossiness | AA | AA | AA | AA | A | B |
| (PMMA/PBMA) | Discharge | B | A | A | A | A | C |
| | performance | | | | | | |
| Comparative | Glossiness | A | B | Not | | | |
| Example 3 | | | | evaluated | | | |
| (CAB) | Discharge | A | C | D | | | |
| | performance | | | | | | |

The results shown in Table 2 revealed that the ink compositions (Examples 1 and 2) according to aspects of the invention allow to further increase glossiness, compared to existing ink compositions (Comparative Examples 1 and 2), while maintaining the viscosity to a level equivalent to those of the existing ink compositions.

The results shown in Table 3 revealed that the ink compositions (Examples 3 and 4) according to aspects of the invention are excellent in metallic gloss and discharge stability compared to those of an existing ink composition (Comparative Example 3). Furthermore, the results of Example 3 revealed that when PMMA was used as the fixing resin component, excellent balance between metallic gloss and discharge stability was particularly achieved in the PMMA content range of 0.2 to 1.5% by mass. The results of Example 4 revealed that when PMMA/PBMA was used as the fixing resin component, excellent balance between metallic gloss and discharge stability was particularly achieved in the PMMA/PBMA content range of 0.5 to 2.0% by mass.

What is claimed is:

1. An ink composition comprising:
a metallic pigment;
a metallic-pigment-fixing resin component containing poly(methyl methacrylate); and
an organic solvent,
wherein poly(isobutyl methacrylate) is not comprised.

2. The ink composition according to claim 1, wherein the fixing resin component further contains poly(butyl methacrylate).

3. The ink composition according to claim 1, wherein the fixing resin component further contains an acrylic resin.

4. The ink composition according to claim 1, wherein the content of the fixing resin component is 0.1 to 2% by mass based on the total amount of the ink composition.

5. The ink composition according to claim 1, wherein the fixing resin component has a glass transition temperature of 60° C. or higher.

6. The ink composition according to claim 1, wherein the metallic pigment has a maximum particle diameter of 12 μm or less.

7. The ink composition according to claim 1, wherein the metallic pigment is aluminum or an aluminum alloy.

8. The ink composition according to claim 1, wherein the ink composition has a viscosity of 8 mPa·s or less at 20° C.
